(19) United States
(12) Patent Application Publication
(10) Pub. No.: US 2017/0046339 A1
(43) Pub. Date: Feb. 16, 2017

(54) MULTIMEDIA SEARCHING

(71) Applicant: AIRWATCH LLC, Atlanta, GA (US)

(72) Inventors: VIJAYKUMAR BHAT, Bangalore (IN); RAMANI PANCHAPAKESAN, Bangalore (IN); MANJUNATH BHAT, Bangalore (IN); ILANCHEZHIAN KUPPUSAMY, Bangalore (IN); SACHIN VAS, Bangalore (IN); YASHASWINI KANTHRAJ, Bangalore (IN); MAHESH KAVATAGE, Bangalore (IN)

(21) Appl. No.: 14/867,022

(22) Filed: Sep. 28, 2015

(30) Foreign Application Priority Data
Aug. 14, 2015 (IN) 4240/CHE/2015

(51) Int. Cl. G06F 17/30

(52) U.S. Cl. CPC G06F 17/3005; G06F 17/30023; G06F 17/30864

(57) ABSTRACT

Disclosed are examples that relate to searching for audio in multimedia files. A transcript specification can be obtained from a file manager that provides restricted access to files associated with an enterprise. The transcript specification can include transcript data representing audio for multiple time segments of a multimedia file. A search result can be generated for a search query. The search result can indicate that the search query matches the transcript data for a particular time segment of the multimedia file. The particular time segment of the multimedia file can be retrieved from the file manager.

### CROSS-REFERENCE TO RELATED APPLICATIONS

Benefit is claimed under 35 U.S.C. 119(a)-(d) to Foreign application Serial No. 4240/CHE/2015 filed in India entitled “MULTIMEDIA SEARCHING”, on Aug. 14, 2015, by AIRWATCH LLC, which is herein incorporated in its entirety by reference for all purposes.

### BACKGROUND

Users of computing devices often store data files that can include various types of content. For example, a user can create and store word processing documents, which can include text and graphics, using a word processing application. When the user wants to view or edit the content in the word processing document, the user can use the word processing application to open the file and render the content.

Users can also store multimedia files. A multimedia player application can render a multimedia file to present audio and video to a user. The multimedia file may not include searchable text. Accordingly, it may be difficult for users to find multimedia files that are of interest. Over time, a user can store a large quantity of multimedia files. Eventually, it can become difficult for the user to locate a particular multimedia file due to the large quantity of files that a user can accumulate. In addition, it is common for multiple users to store multimedia files in the same storage system so that each user has access to all of the multimedia files in the storage system. However, the number of multimedia files stored by the multiple users can make it difficult for one user to find and access a particular multimedia file.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment.

FIG. 2 is a drawing of an example of a portion of a transcript specification for a multimedia file.

FIGS. 3A-3C are drawings of examples of user interfaces rendered by a client device.

FIG. 4 is a flowchart illustrating an example of functionality implemented by a file manager in a computing environment.

FIGS. 5 and 6A-6B are flowcharts illustrating examples of functionality implemented by a file manager client in a client device.

### DETAILED DESCRIPTION

The present disclosure relates to searching for files that can include audio data, such as audio files or multimedia files. In some examples, a server-side enterprise file manager can obtain a multimedia file and define multiple time segments for the multimedia file. For each time segment, the file manager can transcribe audio, such as human speech, that is represented in the multimedia file. The file manager can also generate a transcript specification that represents the audio that is represented within each defined time segment of the multimedia file. Once the file manager has generated the transcript specification, the file manager can transmit the transcript specification to a client device that has access to the multimedia file.

The client device can include a file manager client that can render multimedia files. In addition, the file manager client can generate a search index based on the transcript specifications for multimedia files. A user of the client device can input a search query indicating that the user requests to find time segments of multimedia files that include specified audio, such as a specified phrase of speech. In response to the search query, the file manager client can generate search results that specify one or more time segments of multimedia files that correspond to the user's search query. These segments of video can be downloaded. In this way, the user can easily find time segments of multimedia files that match a specified search query without needing to watch or listen to an entire library of multimedia files. In addition, data transmissions to mobile devices can be minimized by transmitting video segments rather than entire videos.

In the following discussion, examples of systems and their components are described, followed by examples of the operation of those systems.

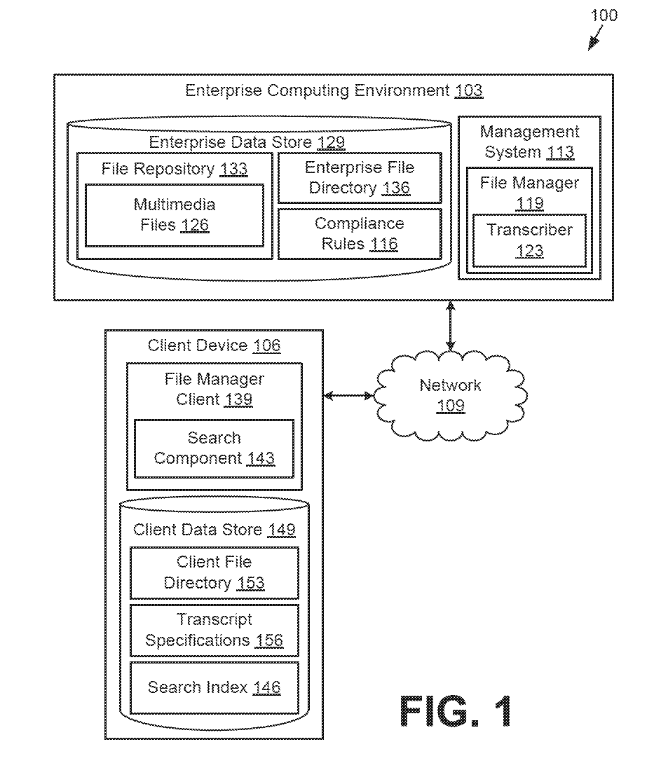

With reference to FIG. 1, shown is an example of a networked environment 100. The networked environment 100 can include an enterprise computing environment 103 and a client device 106 in data communication through a network 109. The network 109 can include the Internet, one or more intranets, extranets, wide area networks (WANs), local area networks (LANs), wired networks, wireless networks, or any combination of two or more such networks. The network 109 can include satellite networks, cable networks, Ethernet networks, and telephony networks.

The enterprise computing environment 103 can be a computing environment operated by one or more enterprises, such as businesses or other organizations. The enterprise computing environment 103 can include a computing device, such as a server computer, that provides computing capabilities. Alternatively, the enterprise computing environment 103 can include multiple computing devices arranged in one or more server banks or computer banks. For examples in which the enterprise computing environment 103 includes multiple computing devices, the computing devices can be located in a single installation, or the computing devices can be distributed among multiple different geographical locations.

In some examples, the enterprise computing environment 103 can include computing devices that together form a hosted computing resource or a grid computing resource. In other examples, the enterprise computing environment 103 can operate as an elastic computing resource for which the allotted capacity of computing-related resources, such as processing resources, network resources, and storage resources, can vary over time. In other examples, the enterprise computing environment 103 can include or be operated as one or more virtualized computer instances that can be executed in order to perform the functionality that is described herein.

The enterprise computing environment 103 can execute various systems. For example, the enterprise computing environment 103 can include a management system 113 that can monitor and manage the operation of client devices 106 that are associated with the enterprise that operates the enterprise computing environment 103. In some examples, the management system 113 can manage and oversee the operation of multiple client devices 106 that are enrolled in a mobile device management service that is provided by the management system 113. The management system 113 can also provide the client devices 106 with access to email, calendar data, contact information, and other resources associated with the enterprise.

Additionally, the management system 113 can assign various compliance rules 116 to respective client devices 106. Each compliance rule 116 can specify, for example, one or more conditions that must be satisfied for a client device 106 to be deemed compliant with the compliance rule 116. In one example, a compliance rule 116 can specify that particular applications are prohibited from being installed in a client device 106. In another example, a compliance rule 116 can specify that a lock screen is required to be generated when the client device 106 is “awoken” from a low power “sleep” state and that a passcode is required for a user to unlock the lock screen. Some compliance rules 116 can be based on time, geographical location, or network properties. For instance, a compliance rule 116 can be satisfied when a client device 106 is located within a particular geographic location. A compliance rule 116 in another example can be satisfied when the client device 106 is in communication with a particular network 109, such as a particular local area network that is managed by the enterprise computing environment 103. Furthermore, a compliance rule 116 in another example can be satisfied upon the time and date matching specified values. Another example of a compliance rule 116 involves whether a user belongs to a particular group of authorized users. Such a compliance rule 116 can include a whitelist or a blacklist that specifies whether particular users or groups of users are authorized users. In various examples, the enterprise computing environment 103, the client device 106, or a combination of both the enterprise computing environment 103 and the client device 106 can determine whether a client device 106 satisfies a compliance rule 116.

In some examples, an employer can operate the management system 113 to ensure that the client devices 106 satisfy various compliance rules 116. By ensuring that the client devices 106 of its employees are operating in compliance with the compliance rules 116, the employer can control and restrict access to resources associated with the employer and the users of the client devices 106.

The management system 113 can include a file manager 119. The file manager 119 can manage files that are associated with the enterprise computing environment 103. For example, the file manager 119 can control and restrict access to files stored in the enterprise computing environment 103. In addition, the file manager 119 can include a transcriber 123. As will be described in further detail below, the transcriber 123 can transcribe audio, such as speech, represented in a multimedia file 126. In addition, the transcriber 123 can translate text from one language to another.

The enterprise computing environment 103 can also include an enterprise data store 129. The enterprise data store 129 shown in FIG. 1 is representative of multiple enterprise data stores 129 that can be accessible to components of the enterprise computing environment 103 or the client device 106.

The enterprise data store 129 can include a file repository 133, an enterprise file directory 136, and the compliance rules 116. The file repository 133 can include files associated with the enterprise computing environment 103. For example, the file repository 133 can include multimedia files 126. The multimedia files 126 can include audio and video data that, when rendered, present audio and video to a user. The data in a multimedia file 126 can be encoded according to various formats, such a Moving Picture Experts Group (MPEG) format or a High Efficiency Video Coding (HEVC) format. Each multimedia file 126 can have a time duration, which can be the time it would take to render the multimedia file 126 from beginning to end at a normal playback speed. For example, a multimedia file 126 can have a time duration of 1 hour and 30 minutes. As will be described in further detail below, the multimedia files 126 can include audio, such as speech, that can be transcribed by the transcriber 123.

The enterprise file directory 136 can include information associated with the multimedia files 126 stored in the file repository 133. For example, the enterprise file directory 136 can include references to the respective storage locations where the multimedia files 126 can be retrieved. In addition, the enterprise file directory 136 can specify individual users or groups of users that are permitted to access the respective multimedia files 126. The enterprise file directory 136 can also include metadata associated with the respective multimedia files 126. For example, for each multimedia file 126, the enterprise file directory 136 can include the name of the multimedia file 126, a description of the multimedia file 126, the creator of the multimedia file 126, a version number of the multimedia file 126, and a list of users who have accessed the multimedia file 126.

The client device 106 is representative of multiple client devices 106 that can be coupled to the network 109. The client device 106 can include a processor-based computer system, such as a desktop computer, a laptop computer, a personal digital assistant, a mobile phone, or a tablet computer. The client device 106 can also include output devices, such as a display and audio speakers, as well as one or more input devices, such as a mouse, keyboard, touch pad, or touch screen, which can facilitate a user interacting with and controlling the client device 106.

The client device 106 can include a file manager client 139. The file manager client 139 can communicate with the file manager 119 to retrieve and store multimedia files 126 associated with the enterprise computing environment 103. In addition, the file manager client 139 can decode multimedia files 126 and render the multimedia files 126 for presentation to a user.

The file manager client 139 can also determine whether various functionality of the file manager client 139 can be enabled or disabled based on whether the client device 106 satisfies particular compliance rules 116. For example, an administrator of the enterprise computing environment 103 can specify a security policy that the management system 113 and file manager client 139 implement to restrict a user's ability to open, edit, or share multimedia files 126 using the file manager client 139 based on whether the client device 106 has satisfied compliance rules 116 assigned to the client device 106.

The file manager client 139 can include a search component 143. The search component 143 can include an indexer that can parse text and generate a search index 146 based on the text. The search component 143 can also include a search engine that can receive search queries and generate search results responsive to the search queries. A user can input a search query, such as a text string, and the search component 143 can generate one or more search results based on the search query, as will be described in further detail below.

The client device 106 can also include a client data store 149. The client data store 149 can include data associated with the client device 106. For example, the client data store 149 can include a client file directory 153, transcript specifications 156, and the search index 146.

The client file directory 153 can include information associated with the multimedia files 126 that are accessible to the client device 106. For instance, the client file directory 153 can include metadata associated with the multimedia files 126 that are accessible to the client device 106. In some examples, for each multimedia file 126 that is accessible to the client device 106, the client file directory 153 can specify the name of the multimedia file 126, a description of the multimedia file 126, the creator of the multimedia file 126, and a version number of the multimedia file 126. In addition, for each multimedia file 126, the client file directory 153 can include data that specifies whether a transcript specification 156 is available for the multimedia file 126.

The client file directory 153 can also specify a popularity metric for each multimedia file 126 associated with the client device 106. As will be described in further detail below, the file manager client 139 can use the popularity metric to determine the ranking of search results presented to a user. A popularity metric can indicate how frequently users associated with the enterprise computing environment 103 have accessed a particular multimedia file 126 relative to other multimedia files 126. Thus, a multimedia file 126 having a relatively high popularity metric can indicate that users have accessed the multimedia file 126 more often than other multimedia files. The file manager 119 can determine the popularity metrics for the multimedia files 126 and provide the file manager client 139 with updated popularity metrics periodically.

A transcript specification 156 can represent a transcript of audio for a multimedia file 126. The transcript specification 156 can include the text of speech or other sounds represented in a multimedia file 126. In some examples, the transcript specification 156 can define multiple time segments for a multimedia file 126, and the transcript specification 156 can include text data representing audio for the respective time segments of the multimedia file 126.

Next, examples of the file manager 119 generating a transcript specification 156 for the multimedia file 126 are described. To begin, the file manager 119 can retrieve a multimedia file 126. In one example, the multimedia file 126 can be stored locally in the client device 106, and the file manager client 139 can transmit the multimedia file 126 to the file manager 119. In other examples, the file manager client 139 can provide the file manager 119 with information that specifies the storage location of the multimedia file 126 and request that the file manager 119 retrieve the multimedia file 126 from the specified location. In one such example, the file manager client 139 can provide the file manager 119 with a uniform resource locator (URL) through which the file manager 119 can retrieve the multimedia file 126.

Once the file manager 119 has obtained the multimedia file 126, the file manager 119 can store the multimedia file 126 in the file repository 133 and create an entry for the multimedia file 126 in the enterprise file directory 136. The file manager 119 can assign the multimedia file 119 a unique identifier and include the unique identifier in the entry of the enterprise file directory 136. The unique identifier can facilitate the file manager 119 identifying and distinguishing the particular multimedia file 126 among the other multimedia files 126 in the file repository 133. The file manager 119 can also include information associated with the multimedia files 126. For example, the file manager 119 can specify a name of the multimedia file 126, a description of the multimedia file 126, a storage location for the multimedia file 126, and an identifier for the user of the client device 106 in the enterprise file directory 136.

Once the file manager 119 has stored information for the multimedia file 126 in the enterprise file directory 136, the file manager 119 can provide the file manager client 139 with information regarding the multimedia file 126. In some examples, the file manager 119 can provide the file manager client 139 with at least a portion of the information included in the entry that the file manager 119 created in the enterprise file directory 136. For example, the file manager 119 can provide the file manager client 139 with information that specifies the unique identifier for the multimedia file 126, a name of the multimedia file 126, a description of the multimedia file 126, and a storage location where the multimedia file 126 is stored in the file repository 133.

Once the file manager client 139 receives the information regarding the multimedia file 126 from the file manager 119, the file manager client 139 can create an entry in the client file directory 153 and store the received information in the entry. Thus, in some examples, the entry in the client file directory 153 can specify the unique identifier for the multimedia file 126, a name of the multimedia file 126, a description of the multimedia file 126, and a storage location where the multimedia file 126 is stored in the file repository 133. In addition, the file manager client 139 can include in the entry data that specifies whether a transcript specification 156 is available for the multimedia file 126. In some examples, the transcript specification 156 is not yet available when the file manager client 139 creates the entry for the multimedia file 126 in the client file directory 153. Accordingly, when initially creating the entry for the multimedia file 126 in the client file directory 153, the file manager client 139 can include in the entry information, such as a flag, specifying that a transcript specification 156 is not available for the multimedia file 126.

After the file manager 119 has provided the information for the multimedia file 126 to the file manager client 139, the file manager 119 can begin the process of transcribing the multimedia file 126. The file manager 119 can begin transcribing the multimedia file 126 in response to various events. In one example, the file manager 119 can begin transcribing the multimedia file 126 upon receiving the multimedia file 126 or once the file manager 119 has provided the information for the multimedia file 126 to the file manager client 139. In another example, the file manager 119 can begin transcribing the multimedia file 126 at a particular time that is specified by an administrator of the enterprise computing environment 103. For instance, an administrator can specify that the file manager 119 is scheduled to transcribe all multimedia files 126 that have not already been transcribed beginning at a time when usage of the enterprise computing environment 103 is expected to be relatively low. In another example, the file manager 119 can monitor the usage of computing resources of the enterprise computing environment 103 and begin transcribing the multimedia file 126 When usage of the computing resources is below a particular threshold.

Once the file manager 119 begins transcribing the multimedia file 126, the transcriber 123 can obtain the multimedia file 126. As will now be described, the transcription process can involve defining multiple time segments for the multimedia file 126 and generating text that represents audio for each defined time segment. In one example, the time segments can be defined prior to the process of generating text that represents audio in the multimedia file 126. In other examples, the time segments can be defined during or after the process of generating text that represents audio in the multimedia file 126.

In one approach, the transcriber 123 can specify a predefined number of time segments for each multimedia file 126 that the transcriber 123 transcribes. In such an example, a multiple multimedia files 126 can have the same number of defined time segments even if the total time durations of the respective multimedia files 126 are different. Thus, a first multimedia file 126 having a time duration of one hour can have the same number of time segments as a second multimedia file 126 having a time duration of two hours.

In another approach, the transcriber 123 can define the time segments so that each time segment begins after a particular number of time units. As one example in accordance with this approach, the first time segment can include the time duration between 0 seconds and 30 seconds, the second time segment can include the time duration between 30 seconds and 60 seconds, and so forth, until time segments have been defined for the entire multimedia file 126.

In some examples, the transcriber 123 can also adjust the time segments so that a time segment does not begin or end at an intermediate point of speech in the multimedia file 126. An intermediate point of speech can be, for example, a point between the beginning and end of a sentence or paragraph. As an example, if a transcribed sentence states, “For every action, there is an equal and opposite reaction,” the transcriber 123 can initially define a time segment that ends between the words “action” and “there,” which is an intermediate point of the sentence. The transcriber 123 can then adjust this time segment so that the adjusted time segment ends after the word “reaction,” instead of at the intermediate point of the sentence. When a video includes multiple speakers, the time segments can also be separated by speaker.

The transcriber 123 can transcribe audio in the multimedia file 126 to generate text data that represents speech and other sounds encoded in the multimedia file 126. For example, if the multimedia file 126 represents a person speaking, the transcriber 123 can transcribe the speech into text data. In addition the transcriber can generate text that represents other sounds, such as birds chirping, in the multimedia file 126.

Once the transcriber 123 has defined the time segments for the multimedia file 126 and has transcribed the multimedia file 126, the transcriber 123 can generate a transcript specification 156 that includes this information. For example, the transcriber 123 can include data that specifies the defined time segments as well as the transcribed text that corresponds to the respective time segments. The defined time segments can be represented in various ways. In one approach, the transcript specification 156 can represent the time segments by specifying the start points and end points of the time segments. As an example, the transcript specification 156 can specify that a particular time segment begins at 3 minutes and ends at 4 minutes in a multimedia file 126. In another approach, the transcript specification 156 can represent the segments by specifying the start points and the time durations of the time segments. As an example, the transcript specification 156 can specify that a particular time segment begins at 3 minutes in the multimedia file 126 and has a duration of 1 minute. In an alternative approach, the transcript specification 156 can represent the time segments by specifying the start points of the time segments, while not specifying the time durations or end points of the time segments.

In some examples, the transcript specification 156 can include an extensible markup language (XML) file that can specify the defined time segments and a transcript of the audio that corresponds to each time segment. In one such example, the XML file can include a time segment XML element for each defined time segment for the multimedia file 126. Each time segment XML element can further include a time XML element and a transcript XML element The time XML element can define the time segment. In one example, the time XML element can specify the start point of the time segment. The transcript XML element of the time segment XML element can represent the transcript of audio that corresponds to the respective time segment.

In some examples, the transcriber 123 can also translate the transcript of audio in the multimedia file 126 from one language to another language and include this translation data in the transcript specification 156 as well. For example, the file manager 119 can include Spanish language text in the transcript specification 156 for a multimedia file 126 that has English language speech. By including the audio transcript in multiple languages, the file manager client 139 can perform a multi-language search, as will be described below.

Once the transcriber 123 has generated the transcript specification 156, the file manager 119 can transmit the transcript specification 156 to the file manager client 139. The file manager client 139 can then store the received transcript specification 156 in the client data store 149. Upon receiving the transcript specification 156, the file manager client 139 can also update the client file directory 153 to include data indicating that the transcript specification 156 is available for the corresponding multimedia file 126. In one example, the entry for the multimedia file 126 in the client file directory 153 can include a field for data that specifies whether the file manager client 139 has received the transcript specification 156. By including this information in the client file directory 153, the file manager client 139 can determine whether transcript data is available for the multimedia file 126.

The file manager client 139 can use the transcript specifications 156 for search functions, as will now be described. In the following description, the file manager client 139 has stored transcript specifications 156 for multiple multimedia files 126 in the client data store 149, allowing searching while the device is offline.

In some examples, the search component 143 of the file manager client 139 can include an indexer. The indexer can generate the search index 146 based on the transcript specifications 156 stored in the client data store 149. The generated search index 146 can correlate words or phrases in the transcript specifications 156 with the multimedia files 126 and the corresponding time segments of the multimedia files 126 for which those words or phrases are represented. For example, the search index 146 can include an entry for a particular word, and the entry can include data identifying the particular multimedia files 126 that include audio in which the word is represented. In addition, the entry in the search index 146 for the word can identify the particular time segments of the multimedia files 126 in which the word is represented, and the speaker by using voice recognition techniques.

A user of the client device 106 can use the file manager client 139 to perform a search for multimedia files 126 having audio in which a particular word or phrase is represented. For instance, a user can input a string of characters that represent a word or phrase. As one example, a user can input the string of “four score and seven years ago,” indicating that the user wants to find multimedia files 126 in which this phrase is represented in the audio. The user can also search by a person's name.

The search component 143 of the file manager client 139 can receive the user's search query and provide this search query to a search engine of the search component 143. The search engine can then search the search index 146 for entries in the search index 146 that match the user's search query. In some examples, the search engine can perform search algorithms that search for synonyms and terms related to the user's search query.

In an alternative example, instead of using the search index 146, the search component 143 can search the transcript specifications 156 for transcription data that matches the user's search query. In these examples, the search component 143 can consult the client file directory 153 to identify the multimedia files 126 for which a transcript specification 156 is available. For each identified multimedia file 126, the search component 143 can parse the transcription data representing audio in the multimedia file 126 to determine whether time segments of the multimedia file 126 include audio that matches the user's search query.

As mentioned above, for each time segment represented in a transcript specification 156, the file manager 119 can translate text from one language to another language and include the resulting translation in the transcript specification 156. For example, the file manager 119 can include Spanish language text in the transcript specification 156 for a multimedia file 126 that has English language speech. If a user provides a search query that includes Spanish language text, the search component 143 can determine whether the search query matches the Spanish language text represented in either the search index 146 or the transcript specifications 156.

If the search component 143 determines that there are one or more entries in the search index 146 or the transcript specifications 156 that match the user's search query, the search component 143 can retrieve the information for those entries from the search index 146 or the transcript specifications 156. In addition, the search component 143 can encode and render the retrieved information in a user interface for presentation to a user. For example, the user interface can present the names and descriptions of the corresponding multimedia files 126. In addition, the user interface can specify the respective time segments of the multimedia files 126 in which the audio corresponding to the user's search query is located.

The search component 143 can also rank the generated search results based on the popularity metrics associated with the respective multimedia files 126. For example, the search component 143 can rank a search result with the highest popularity metric higher than other search results. In addition, when the file manager client 139 renders the search results for presentation to a user, the search results can be presented in an order based on the rankings assigned by the search component 143. A popularity metric can represent how often a multimedia file 126 has been accessed by other users associated with the enterprise that operates the enterprise computing environment 103. Thus, the popularity metric, can indicate that a particular multimedia file 126 is relatively important or interesting for users of the enterprise computing environment 103. Therefore, the file manager client 139 can rank a multimedia file 126 having a relatively high popularity metric relatively high in the search results so that a user is more likely to notice the multimedia file 126.

After the file manager client 139 renders the search results in a user interface, the user of the client device 106 can select one of the search results. In response to the user's selection, the file manager client 139 can retrieve at least a portion of the corresponding multimedia file 126. In some examples, the file manager client 139 can retrieve the multimedia file 126 from the client data store 149. In other examples, the multimedia file 126 can be stored remotely in the file repository 133 of the enterprise computing environment 103. In these examples, the file manager client 139 can request the multimedia file 126 from the file manager 119 by transmitting a message to the file manager 119 with the unique identifier for the multimedia file 126. In response to the request, the file manager 119 can transmit the requested multimedia file 126 to the client device 106. In an alternative example, the file manager 119 can transmit a reference, such as a URL that the file manager client 139 can use to retrieve the requested multimedia file 126.

In some examples, the file manager client 139 can retrieve the entire corresponding multimedia file 126 in response to the user selecting a corresponding search result. In other examples, the file manager client 139 can retrieve only a portion of the multimedia file 126 in response to the user's selection. In one such example, the file manager client 139 can retrieve only the portion of the multimedia file 126 that corresponds to the time segment of the selected search result. In this way, the file manager client 139 can reduce network and computing resources used to retrieve the portion of the multimedia file 126 in which the user is interested.

In some examples, prior to retrieving the multimedia file 126 corresponding to a selected search result the file manager client 139, the file manager client 139 can determine whether the client device 106 satisfies the compliance rules 116 associated with the client device 106. For example, the file manager client 139 can determine whether settings or the state of the client device 106 match requirements specified by the respective compliance rules 116. If not, the file manager client 139 can initiate an action, such as notifying the user of the client device 106, notifying an administrator of the enterprise computing environment 103, locking the client device 106, or deleting data from the client device 106. If the client device 106 satisfies the compliance rules 116, the file manager client 139 can proceed with retrieving the multimedia file 126 that corresponds to the selected search result.

After the file manager client 139 has obtained at least the portion of the multimedia file 126 that corresponds to the selected search result, the file manager client 139 can decode and begin rendering the multimedia file 126. In some examples, the file manager client 139 can begin the rendering of the multimedia file 126 at the start point of the time segment that corresponds to the selected search result. The multimedia file 126 could otherwise begin rendering at the beginning of the multimedia file 126. By starting the rendering of the multimedia file 126 at the start point of the time segment corresponding to the selected search result, the file manager client 139 can present the user with the portion of the multimedia file 126 that matches the user's search request without the user having to watch or fast forward through other portions of the multimedia file 126.

In some examples, instead of the search being performed on the client device 106, the search component 143 can perform the search. In such an example, the file manager 119 can generate a search index 146 based on the transcript specifications 156 of the multimedia files 126 associated with users of the enterprise computing environment 103. When a user inputs a search query into the file manager client 139, the file manager client 139 can transmit the search query, and the file manager 119 can search the search index 146 or the transcript specifications 156 for matches for the search query. In another example, a search can begin on the client device 106, and initial results can be provided to a user, and then the search can continue in more depth in the computing environment 103.

The file manager 119 can generate search results using the information in entries in the search index 146 or the transcript specification 156. Once the file manager 119 has generated the search results, the file manager 119 can transmit the search results to the file manager client 139 for presentation, similar to the examples described above. In some examples, the management system 113 may prevent the client device 106 from having access to one or more multimedia files 126 that correspond to the generated search results. Accordingly, the file manager 119 can determine whether the multimedia file 126 for each generated search result is accessible to the client device 106. If a multimedia file 126 is not accessible to the client device 106, the file manager 119 may not transmit the corresponding search result for the multimedia file 126.

Alternatively, the file manager 119 can transmit the search result even if the multimedia file 126 is not accessible to the client device 106. The file manager client 139 can render the search result for presentation to the user, and if user wants to obtain the multimedia file 126, the file manager client 139 can transmit a request for the multimedia file 126 to the file manager 119. When the file manager 119 obtains the request for the multimedia file 126, the file manager 119 can present the request to an administrator of the enterprise computing environment 103 who can then determine whether to grant the client device 106 authorization to access the requested multimedia file 126.

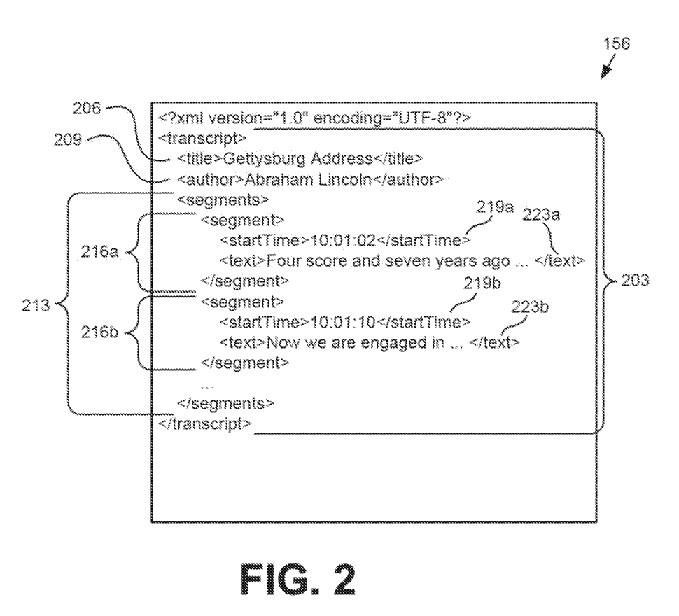

With reference to FIG. 2, shown is an example of a transcript specification 156. The transcript specification 156 shown in FIG. 2 is an XML file that includes XML code. As shown, the transcript specification 156 can include several XML elements. Each XML element can begin with an XML start tag and end with a corresponding XML end tag.

For the example shown in FIG. 2, the transcript specification 156 includes a transcript XML element 203. In addition, the transcript XML element 203 can include sub-elements. For example, the transcript XML element 203 can include a title XML element 206, an author XML element 209, and a segments XML element 213. The title XML element 206 can specify a name for the corresponding multimedia file 126. In the example shown, the name for the multimedia file is “Gettysburg Address.” The author XML element 209 can specify an author for the corresponding multimedia file 126. In the example shown, the author for the multimedia file 126 is “Abraham Lincoln.”

The segments XML element 213 can include information regarding the defined time segments for the multimedia file 126. For the example shown in FIG. 2, the segments XML element 213 includes multiple segment XML elements 216a-216b. Each segment XML element 216a-216b can define a respective time segment and specify transcript data for the time segment. For the example in FIG. 2, each segment XML element 216a-216b includes a start time XML element 219a-219b and a text XML element 223a-223b. Each start time XML element 219a-219b can specify the start point of the corresponding time segment of the multimedia file 126. The text XML elements 223a-223b can include the text of the transcript for the respective time segment of the multimedia file 126. While an exemplary transcript file is shown in FIG. 2, other types of transcript files can also be used.

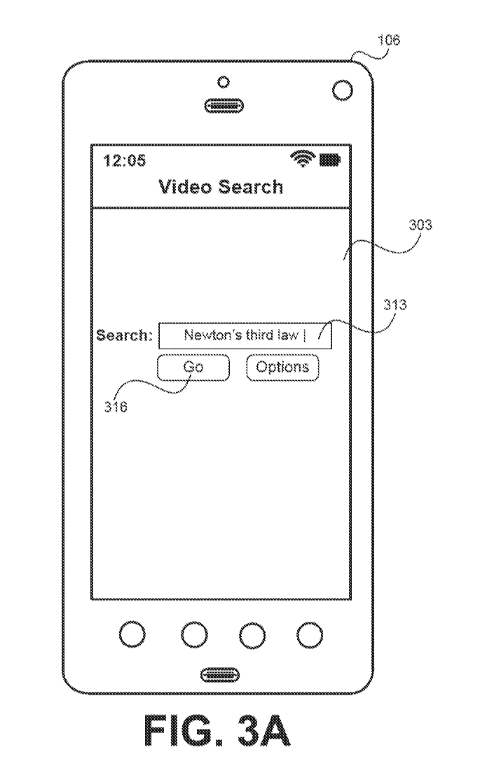

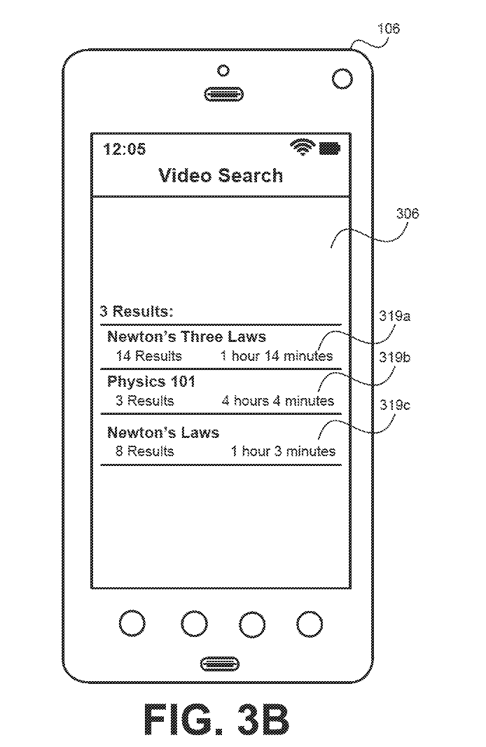

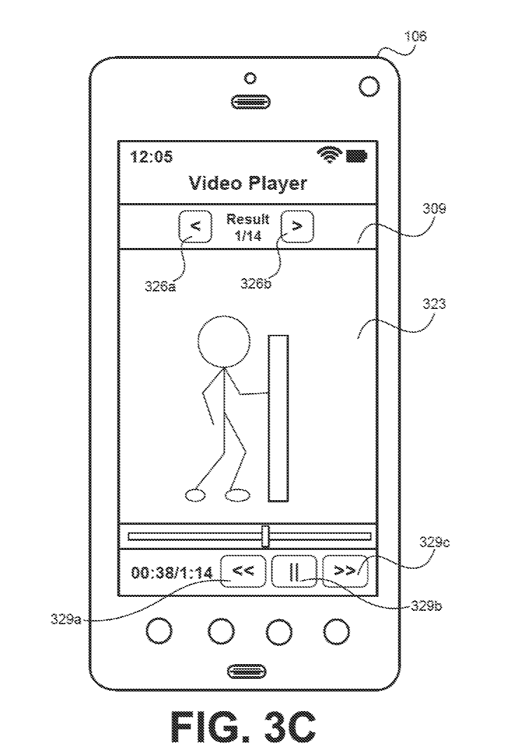

With reference to FIGS. 3A-3C, shown are examples of user interfaces 303, 306, 309 that can be rendered by the client device 106 when a user performs a search using the file manager client 139. Beginning with FIG. 3A, the user interface 303 can include a search query input region 313 and a go button 316. The user can input a search query into the search query input region 313. In the example shown in FIG. 3A, the user has entered the text string of “Newton's third law” into the search query input region 313. If the user of the client device 106 selects the go button 316, the search component 143 of the file manager client 139 can search the transcript specifications 156 or the search index 146 for a match.

With reference to FIG. 3B, the client device 106 can render the user interface 306 after the search component 143 has generated search results for the user's search query input in the search query input region 313. For the example shown in FIG. 3B, the search component 143 generated several search results for the search query of “Newton's third law.” The presentations 319a-319c of the search results for the example shown in FIG. 3B specify the names and the total time durations of the multimedia files 126. A user can select one of the presentations of 319a-319c of the search results in the user interface 306, and the file manager client 139 can retrieve the corresponding multimedia file 126, as described above.

With reference to FIG. 3C, the file manager client 139 can generate the user interface 309 after a user has selected one of the presentations 319a-319c of the search results in the user interface 306. The user interface 309 includes a rendering 323 of the multimedia file 126. For the example shown in FIG. 3C, the file manager client 139 has begun rendering the multimedia file 126 at the start point of a time segment that matched the user's search query.

The user interface 309 shown in FIG. 3 includes search result seek buttons 326a-326b that a user can select to progress to other time segments in the multimedia file 126 that matched the user's search query. The user interface 309 also includes playback controls 329a-329c that a user can select to control the rendering of the multimedia file 126. For example, the user can select the playback controls 329a or 329c to adjust the rendering position to an earlier or later time of the multimedia file 126. The user can select the playback control 329b to pause the rendering of the multimedia file 126.

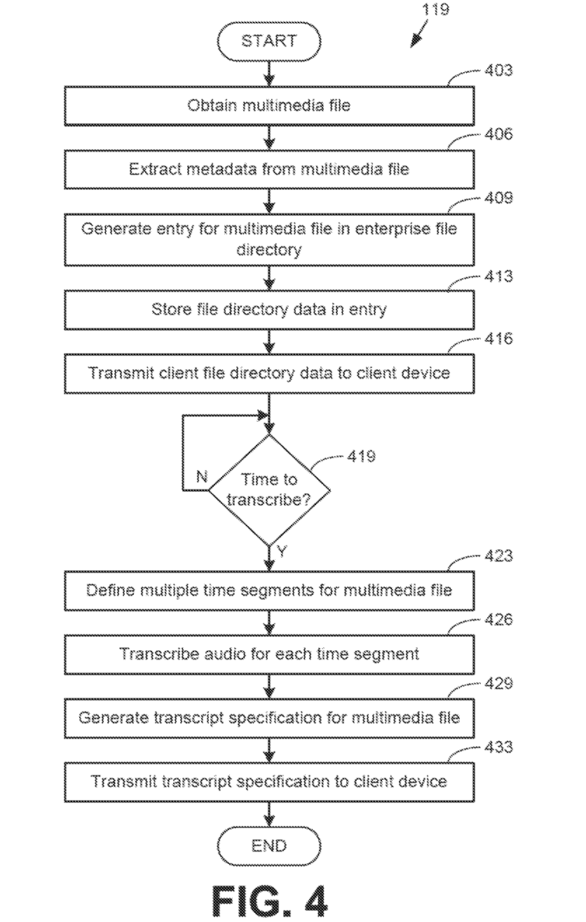

With reference to FIG. 4, shown is a flowchart that provides an example of a portion of the operation of the file manager 119. In particular, FIG. 4 provides an example of the file manager 119 generating a transcript specification 156 for a multimedia file 126. The flowchart of FIG. 4 can be viewed as depicting an example of a method implemented in the enterprise computing environment 103. The systems and methods described can also be applied in non-enterprise environments.

Beginning with step 403, the file manager 119 can obtain a multimedia file 126. In one example, the client device 106 can provide the file manager 119 with the multimedia file 126. In another example, the client device 106 can provide the file manager 119 with a reference, such as a URL to a storage location of the multimedia file 126, and the file manager 119 can retrieve the multimedia file 126 from the storage location.

As shown at step 406, the file manager 119 can then extract metadata from the multimedia file 126. The extracted metadata can include information associated with the multimedia file 126 such as the name of the multimedia file 126 and an author of the multimedia file 126. The file manager 119 can then move to step 409 and generate the entry for the multimedia file 126 in the enterprise file directory 136. As shown at step 413, the file manager 119 can store file directory data in the entry of the enterprise file directory 136. The file directory data can include the extracted metadata as well as other information. For instance, the file directory data can include a unique identifier for the multimedia file 126, the name of the multimedia file 126, a description of the multimedia file 126, a version number of the multimedia file 126, the creator of the multimedia file 126, a list of users who have accessed the multimedia file 126, and a popularity metric for the multimedia file 126.

At step 416, the file manager 119 can transmit data for the client file directory 153 to the client device 106. The transmitted data can be based on the data in the enterprise file directory 136. For example, the transmitted data for the client file directory 153 can specify the name of the multimedia file 126, a description of the multimedia file 126, the creator of the multimedia file 126, a version number of the multimedia file 126, data that specifies whether a transcript specification 156 is available for the multimedia file 126, and a popularity metric for the multimedia file 126.

As shown at step 419, the file manager 119 can then wait until it is time to begin transcribing the multimedia file 126. In one example, the file manager 119 can determine to begin transcribing the multimedia file 126 upon receiving the multimedia file 126 or once the file manager 119 has provided the information for the multimedia file 126 to the file manager client 139. In another example, the file manager 119 can begin transcribing the multimedia file 126 at a scheduled time that is specified by an administrator of the enterprise computing environment 103. In another example, the file manager 119 can begin transcribing the multimedia file 126 after determining that the usage of computing resources for the enterprise computing environment 103 is below a particular threshold.

Once the file manager 119 determines that it is time to transcribe the multimedia file 126, the file manager 119 can move to step 423 and define multiple time segments for the multimedia file 126. In some examples, the file manager 119 can define a predetermined number of time segments for the multimedia file 126. In another example, the file manager 119 can define the time segments so that each time segment begins after a particular number of time units. In addition, the file manager 119 can adjust defined time segments so that a time segment does not begin or end at an intermediate point of speech in the multimedia file 126.

As indicated at step 426, the file manager 119 can then transcribe the audio of the multimedia file 126 for each defined time segment. By transcribing the audio for each time segment, the file manager 119 can generate text data that represents audio in the multimedia file 126. The text data can represent speech or other sounds represented in the multimedia file 126.

At step 429, the file manager 119 can generate the transcript specification 156 for the multimedia file 126. The transcript specification 156 can include text representing speech or other sounds for the respective time segments defined for the multimedia file 126. As described above, the transcript specification 156 can include an XML file in an example.

The file manager 119 can then transmit the transcript specification 156 to the client device 106, as indicated at step 433. Thereafter, the process ends.

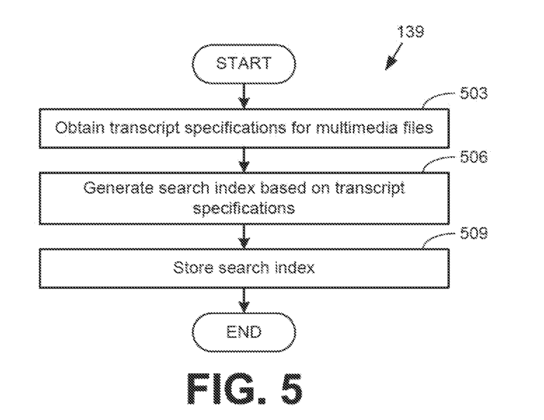

With reference to FIG. 5, shown is a flowchart that provides an example of a portion of the operation of the file manager client 139. In particular, FIG. 5 provides an example of the file manager client 139 generating a search index 146 based on transcript specifications 156. The flowchart of FIG. 5 can be viewed as depicting an example of a method implemented in the client device 106.

Beginning with step 503, the file manager client 139 can obtain transcript specifications 156 for multiple multimedia files 126. As described above, the transcript specifications 156 can include text of speech or other sounds represented in the time segments defined for respective multimedia file 126.

The file manager client 139 can then move to step 506 and generate a search index 146 based on the received transcript specifications 156. The generated search index 146 can correlate words or phrases in the transcript specifications 156 with the multimedia files 126 and the time segments of the multimedia files 126 in which those words or phrases are represented.

At step 509, the file manager client 139 can then store the search index 146 in the client data store 149 for later use by the search component 143 of the file manager client 139. Thereafter, the process ends.

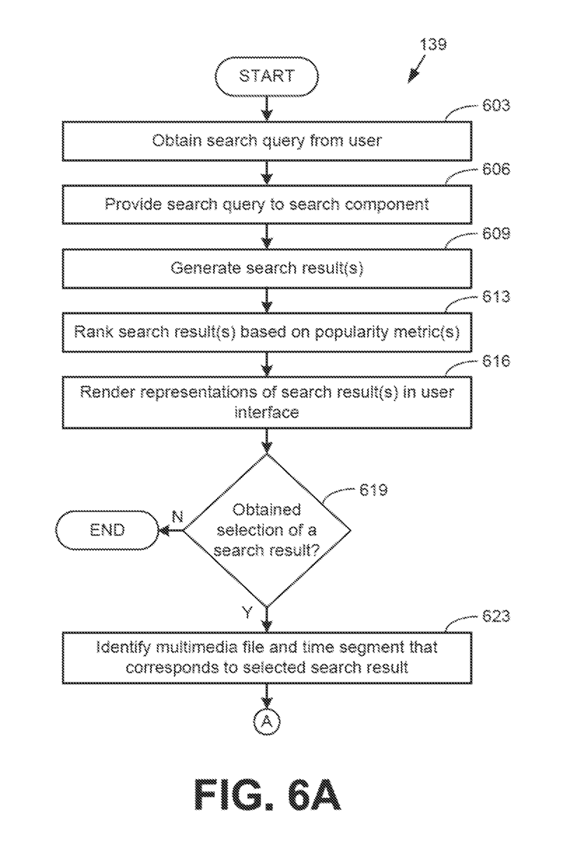

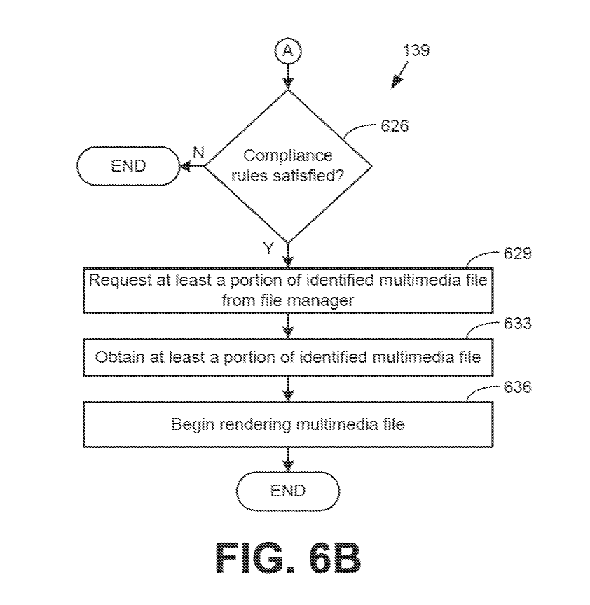

With reference to FIGS. 6A-6B, shown is a flowchart that provides an example of a portion of the operation of the file manager client 139. In particular, FIG. 6A-6B provides an example of the file manager client 139 processing a search query. The flowchart of FIGS. 6A-6B can be viewed as depicting an example of a method implemented in the client device 106.

Beginning with step 603, the file manager client 139 can obtain a search query from a user of the client device 106. The search query can include, for example, a text string input by the user. As shown at step 606, the file manager client 139 can then provide the search query to the search component 143 of the file manager client 139.

The file manager client 139 can then generate search results that correspond to the search query, as indicated at step 609. Each search result can include information that specifies a time segment of a multimedia file 126 that includes audio that matches the user's search query. As shown at step 613, the file manager client 139 can also rank the generated search results based on the popularity metrics associated with the multimedia files 126. A popularity metric can indicate how frequently users associated with the enterprise that provides the enterprise computing environment 103 have accessed a particular multimedia file 126 relative to other multimedia files 126. In addition, users within an enterprise can belong to different groups. Popularity results can be based on relevance of a video segment to the group(s) to which a user executing a search belongs.

At step 616, the file manager client 139 can render representations of the search results in a user interface. The representations of the search results can be ordered based on the rankings of the search results. In this way, the file manager client 139 can direct the user's attention to search results that correspond to multimedia files 126 that are relatively popular among users associated with the enterprise computing environment 103.

As shown at step 619, the file manager client 139 can determine whether the file manager client 139 has obtained a user selection of one of the search results represented in the user interface. If a user has not selected one of the search results, the process ends. Otherwise, if a user has selected one of the search results, the file manager client 139 can move to step 623 and identify the multimedia file 126 as well as the time segment of the multimedia file 126 that corresponds to the selected search result. In some examples, this information can be included in the search result. In other examples, the file manager client 139 can consult the corresponding transcript specification 156 or the search index 146 to identify this information.

At step 626 the file manager client 139 can determine whether the client device 106 satisfies the compliance rules 116 associated with the client device 106. To this end, the file manager client 139 can determine whether settings or states of the client device 106 match requirements specified by the compliance rules 116. If the client device 106 does not satisfy the compliance rules 116, the process can end. In addition, the file manager client 139 can notify a user of the client device 106 or an administrator of the enterprise computing environment 103 that the client device 106 does not satisfy the compliance rules 116. Furthermore, the file manager client 139 perform a remedial action, such as erasing data from the client device 106, if the client device 106 does not satisfy the compliance rules 116.

If the client device 106 does satisfy the compliance rules 116, the file manager client 139 can move to step 629 and request at least a portion of the identified multimedia file 126 from the file manager 119. In some examples, the file manager client 139 can request the entire multimedia file 126. In other examples, the file manager client 139 can request only the portions of the multimedia file 126 that correspond to the time segment for the selected search result.

As shown at step 633, the file manager client 139 can then obtain at least a portion of the requested multimedia file 126. In some examples, the file manager 119 can provide the multimedia file 126. In other examples, the file manager 119 can provide a storage location reference, such as a URL, that the file manager client 139 can use to retrieve the multimedia file 126.

The file manager client 139 can then begin rendering the multimedia file 126, as shown at step 636. In some examples, the file manager client 139 can begin rendering the multimedia file 126 at the start point of the time segment specified by the search result selected by the user. For example, if the search result specifies that the start point of the time segment for the multimedia file is 30 seconds into the multimedia file 126, the file manager client 139 can begin rendering the multimedia file 126 at the point that is 30 seconds into the multimedia file 126. Thereafter, the process ends.

The flowcharts of FIGS. 4, 5, and 6A-6B show examples of the functionality and operation of implementations of components described herein. The components of the networked environment 100 described herein can be embodied in hardware, software, or a combination of hardware and software. If embodied in software, each step in the flowcharts of FIGS. 4, 5, and 6A-6B can represent a module or a portion of code that includes computer instructions to implement the specified logical functions. The computer instructions can be embodied in the form of source code that comprises human-readable statements written in a programming language or machine code that comprises machine instructions recognizable by a suitable execution system, such as a processor in a computer system. If embodied in hardware, each step can represent a circuit or a number of interconnected circuits that implement the specified logical functions.

Although the flowcharts show a specific order of execution, it is understood that the order of execution can differ from that which is shown. For example, the order of execution of two or more steps can be switched relative to the order shown. Also, two or more steps shown in succession can be executed concurrently or with partial concurrence. Further, in some examples, one or more of the steps shown in the flowcharts can be skipped or omitted. In addition, any number of counters, state variables, warning semaphores, or messages can be added to the logical flow described herein, for purposes of enhanced utility, accounting, performance measurement, or troubleshooting aid. All such variations are within the scope of the present disclosure.

The enterprise computing environment 103 and client device 106 described herein can each include at least one processing circuit. The processing circuit can include one or more processors and one or more storage devices that are coupled to a local interface. The local interface can include a data bus with an accompanying address/control bus.

A storage device for a processing circuit can store data and components that are executable by the one or more processors of the processing circuit. In some examples portions of the management system 113 and the file manager client 139 can be stored in one or more storage devices and be executable by one or more processors. Also, the enterprise data store 129 and the client data store 149 can be located in the one or more storage devices.

The management system 113 and the file manager client 139 can be embodied in the form of hardware, as software components that are executable by hardware, or as a combination of software and hardware. If embodied as hardware, the components described herein can be implemented as a circuit or state machine that employs any suitable hardware technology. Such hardware technology includes, for example, one or more microprocessors, discrete logic circuits having logic gates for implementing various logic functions upon an application of one or more data signals, application specific integrated circuits (ASICs) having appropriate logic gates, or programmable logic devices, such as field-programmable gate array (FPGAs) and complex programmable logic devices (CPLDs).

Also, one or more or more of the components described herein that include software or computer instructions can be embodied in any non-transitory computer-readable medium for use by or in connection with an instruction execution system such as, for example, a processor in a computer system or other system. Such a computer-readable medium can contain, store, and maintain the software or computer instructions for use by or in connection with the instruction execution system.

A computer-readable medium can comprise a physical media, such as, magnetic, optical, semiconductor, or other suitable media. Examples of a suitable computer-readable media include solid-state drives, magnetic drives, flash memory, and storage discs, such as compact discs (CDs). Further, any logic or component described herein can be implemented and structured in a variety of ways. For example, one or more components described can be implemented as modules or components of a single application. Further, one or more components described herein can be executed in one computing device or by using multiple computing devices.

The examples described above are merely examples of implementations to set forth for a clear understanding of the principles of the disclosure. Many variations and modifications can be made to the examples described above without departing substantially from the spirit and principles of the disclosure. All such modifications and variations are intended to be included herein within the scope of this disclosure.

Therefore, the following is claimed:

1. A system, comprising:
a computing device; and
a file manager client executable by the computing device, wherein the file manager client, when executed by the computing device, is configured to cause the computing device to at least:
obtain a transcript specification from a file manager that provides restricted access to a plurality of files associated with an enterprise, wherein the transcript specification comprises transcript data representing audio for a plurality of time segments of a multimedia file;
obtain a search query from a user;
generate a search result for the search query, wherein the search result indicates that the search query matches the transcript data for a particular time segment of the multimedia file;
determine whether the computing device satisfies a compliance rule; and
responsive to determining that the computing device satisfies the compliance rule, retrieve the particular time segment of the multimedia file from the file manager.

2. The system of claim 1, wherein the transcript specification comprises:
a first transcript element that represents the audio from a first time segment of the multimedia file;
a first time element that specifies a first start point of the first time segment of the multimedia file;
a second transcript element that represents the audio from a second time segment of the multimedia file; and
a second time element that specifies a second start point of the second time segment of the multimedia file.

3. The system of claim 1, wherein the transcript specification comprises an extensible markup language (XML) file.

4. The system of claim 3, wherein the XML file comprises an XML element comprising:
a start time XML element that specifies a start point of the particular time segment; and
a text XML element that comprises a text transcription for the particular time segment.

5. The system of claim 1, wherein the file manager client is further configured to cause the computing device to at least render the multimedia file beginning at a start point of the particular time segment of the multimedia file.

6. The system of claim 1, wherein the file manager client is further configured to cause the computing device to at least:
store file directory data for the multimedia file prior to obtaining the transcript specification, wherein the file directory data indicates that the transcript specification is not available to the file manager client; and
upon obtaining the transcript specification, updating the file directory data to indicate that the transcript specification is available to the file manager client.

7. The system of claim 1, wherein the file manager client is further configured to cause the computing device to at least:
obtain a plurality of transcript specifications from the file manager; and
generate a search index based on the plurality of transcript specifications.

8. A non-transitory computer-readable medium storing a plurality of computer instructions executable by a computing device, the plurality of computer instructions being configured to cause the computing device to at least:
obtain a transcript specification from a file manager that provides restricted access to a plurality of files associated with an enterprise, wherein the transcript specification comprises transcript data representing audio for a plurality of time segments of a multimedia file;
obtain a search query from a user;
generate a search result for the search query, wherein the search result indicates that the search query matches the transcript data for a particular time segment of the multimedia file; and
retrieve the particular time segment of the multimedia file from manager responsive to a user selection of the search result.

9. The non-transitory computer-readable medium of claim 8, wherein the plurality of computer instructions are further configured to cause the computing device to at least:
determine whether a compliance rule is satisfied; and
relieve the particular time segment of the multimedia file in response to determining that the compliance rule is satisfied.

10. The non-transitory computer-readable medium of claim 8, wherein the plurality of computer instructions are further configured to cause the computing device to at least transmit a request to the file manager for only the particular time segment of the multimedia file.

11. The non-transitory computer-readable medium of claim 8, wherein the plurality of computer instructions are further configured to cause the computing device to at least render the multimedia file beginning at a start point of the particular time segment of the multimedia file.

12. The non-transitory computer-readable medium of claim 8, wherein the transcript specification comprises an extensible markup language (XML) file.

13. The non-transitory computer-readable medium of claim 12, wherein the XML element comprises an XML element comprising:
a start time XML element that specifies a start point of the particular time segment; and
a text XML element that comprises a text transcription for the particular time segment.

14. A method, comprising:
obtaining a transcript specification from a file manager that provides restricted access to a plurality of files associated with an enterprise, wherein the transcript specification comprises transcript data representing audio for a plurality of time segments of a multimedia file;
obtaining a search query;
generating a search result for the search query, wherein the search result indicates that the search query matches the transcript data for a particular time segment of the multimedia file; and
retrieve the particular time segment of the multimedia file from the file manager.

15. The method of claim 14, further comprising determining whether a computing device complies with a compliance rule prior to retrieving the particular time segment of the multimedia file.

16. The method of claim 14, wherein the transcript specification comprises an extensible markup language (XML) file.

17. The method of claim 16, wherein the XML file comprises transcript data that represents speech in a first language and a second language.

18. The method of claim 16, wherein the XML file comprises an XML element comprising:
a start time XML element that specifies a start point of the particular time segment; and
a text XML element that comprises a text transcription for the particular time segment.

19. The method of claim 14, further comprising rendering the multimedia file beginning at a start point of the particular time segment of the multimedia file.

20. The method of claim 14, farther comprising ranking the search result based on a popularity metric that indicates a popularity of the multimedia file at an enterprise.
